(19) United States
(12) Patent Application Publication
(10) Pub. No.: US 2007/0173364 A1
(43) Pub. Date: Jul. 26, 2007

(54) Sprocket

(75) Inventor: Andrew Charles Renshaw, Macclesfield (GB)

Correspondence Address: OLIFF & BERRIDGE, PLC, P.O. BOX 19928, ALEXANDRIA, VA, 22320, US

(73) Assignee: RENTHAL LIMITED, Bredbury (GB)

(21) Appl. No.: 11/506,926

(22) Filed: Aug. 21, 2006

(30) Foreign Application Priority Data
Jan. 20, 2006 (GB) 0601150.6

(51) Int. Cl. F16H 55/30; F16H 55/12

(52) U.S. Cl. 474/160; 474/152

(57) ABSTRACT

An annular plate, which is of a first material and has a toothed external periphery, is shrink fitted onto the perimeter of a disc of a second material so that there is no play between the annular plate and the disc. The perimeter of the disc includes at least one radially recessed region and the annular plate has its inner edge provided with corresponding one or more protruding regions which fit thereto. A plurality of fasteners, such as grub screws, are inserted axially at spaced intervals between the annular plate and the disc.

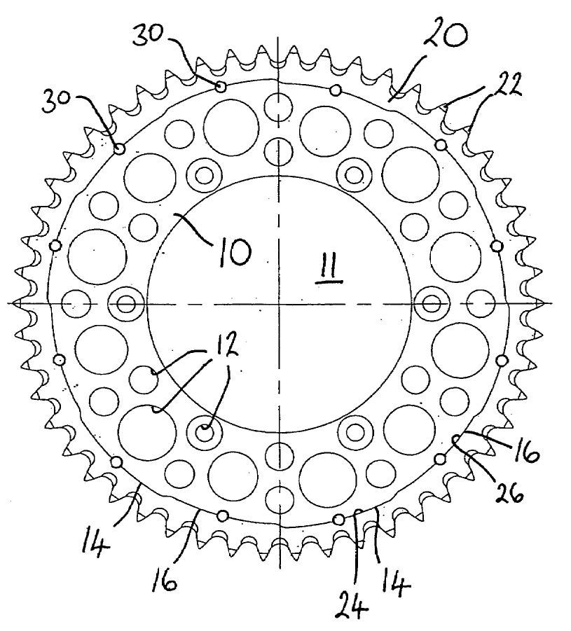

### TECHNICAL FIELD

This invention concerns a sprocket, sometimes known as a chain wheel, for bicycles, motorcycles and similar wheeled vehicles.

### BACKGROUND ART

Sprockets are conventionally formed in one piece as substantially circular discs of metal having teeth around the perimeter, and having various inner sections cut way to reduce weight. Since aluminium is light in weight, and many bicycle and motorcycle parts are made from aluminium for this reason, it has recently been proposed to produce a sprocket by attaching a toothed steel annulus around the perimeter of a circular aluminium disc, the steel providing the necessary strength and wear resistance for the toothed perimeter. The aluminium disc and/or the steel annulus is provided with a series of projections or “ears” which overlie the other part and by means of which the parts are riveted together. This has not proved to be satisfactory as the risk of the steel annulus detaching from the central aluminium disc after a period of use is too great and failure during use could prove fatal.

In WO 2004/018902 of Supersprox, a.s. ears provided on the toothed annulus fit into corresponding pocket-like recesses provided at intervals around the central disc, the ears and the regions defining the recesses in each case being reduced in thickness compared to the thickness of the remainder of the annulus and the disc, respectively.

In the applicant's earlier GB 2396396 a proposal was made for attaching the toothed annulus around the perimeter of the disc by threadedly engaging the inner edge of the annulus with the perimeter edge of the disc prior to use of at least one pin or rivets to additionally connect the two parts.

### OBJECT OF THE INVENTION

The present invention aims to provide another manner in which a toothed annulus of a first material may be connected, more reliably and securely than hitherto, to a central disc of a second material.

### SUMMARY OF THE INVENTION

According to the invention a sprocket comprises an annular plate, which is of a first material and has a toothed external periphery, shrink fitted onto the perimeter of a disc of a second material so that there is no play between the annular plate and the disc, the perimeter of the disc having at least one radially recessed region and the annular plate having its inner edge provided with corresponding one or more protruding regions which fit thereto, and a plurality of fasteners inserted axially at spaced intervals between the annular plate and the disc.

The fasteners should be of a type which will reliably resist any axial (sideways) displacement of the disc or the annular plate relative to the other, as may be liable to occur upon impact to the sprocket in use, for example if used on a motorcycle ridden for motocross events.

In practice, the interfitting of such radially recessed and protruding regions is important to ensure that relative rotation between the annular plate and the disc is reliably prevented in all situations of use, including where the sprocket is used on a motorcycle or cycle which is ridden over rough terrain or in competitions

### BRIEF DESCRIPTION OF THE DRAWINGS

The invention will be described further, by way of example, with reference to the accompanying drawing in which the single figure is a plan view of a preferred practical embodiment of the sprocket of the invention.

### DETAILED DESCRIPTION

With reference to the drawing, a preferred practical embodiment of the sprocket of the invention comprises a central disc 10 of an aluminium alloy or other suitable material mounted inside a toothed annular plate 20 of steel or other suitable material.

The disc 10 is itself of generally annular form, having a large central aperture 11. It also has a symmetrical pattern of other apertures 12 as a means to reduce weight, reduce material and for decorative purposes. The actual pattern is obviously immaterial to the invention.

Typical dimensions for the disc 10 are a diameter in the region of 15 to 30 cm and a thickness from about 2 mm up to about 10 mm.

The perimeter of the disc 10 comprises alternate first sections 14 and second sections 16 which merge into each other. In this particular embodiment there are six repeats of first section 14 and adjoining second section 16. Each repeat is substantially identical and takes up an angular extend of 60° of the total circumference of the disc 10.

The second sections 16 are radially recessed compared to the first sections 14 which means they lie at a shorter distance than the first sections 14 from the centre point C of the sprocket (or the disc 10). The actual form of the recesses and intervening protrusions formed in the periphery of the disc 10 are not material to the invention. They could, in other embodiments, be larger or smaller than in the illustrated embodiment. Typically, the radial difference between the sections 14 and 16 is from 1 to 5 mm.

The toothed annular plate 20 fits over the disc 10 and therefore has a corresponding internal diameter in the region of 15 to 30 cm. It may be for example, from 2 cm to 5 cm in width, thus having an external diameter from, say, 24 to 35 cm, in proportion. Its thickness will generally match that of the disc 10, but that is not essential.

The illustrated annular plate 20 has fifty teeth 22 around its outer circumference. In other embodiments anything upwards of twenty teeth would be typical.

The annular plate 20 has an inner edge comprising alternate first sections 24 and second sections 26, which match the first and second sections 14, 16 of the disc 10 in their extent. In this case the first sections 24 are radially recessed compared to the second sections 26, but in the case of the annular plate 20 this means that the first inner edge sections 24 lie at a greater distance from the centre C of the sprocket than the second sections 26.

In order to produce the combined sprocket, the disc 10 and the annular plate 20 are formed separately with closely corresponding outer periphery and inner edge configurations, but with the inner edge of the annular steel plate 20 of slightly smaller diameter than the outer periphery of the disc 10. Typically, the inner edge diameter of the annular plate 20 might be 0.05 to 0.2 mm less than the outer diameter of the disc 10. The annular steel plate 20 is then heated, typically to a temperature of about 150°, until it has expanded to have a clearance of at least 0.1 mm compared to the diameter of the disc 10. The disc 10 is then dropped into the inside of the annular plate 20, and the latter is allowed to cool and shrink into a close fit around the disc 10. This achieves a reliable tight fit with no play radially or circumferentially, or indeed axially between the disc 10 and the annular plate 20.

Fasteners 30 are inserted at spaced intervals around the join between the annular plate 20 and the disc 10 by drilling and tapping after the shrink fit of the annular plate 20 has been achieved. Grub screws, also known as set screws, are the preferred type of fastener 30. In the illustrated embodiment, respective grub screws 30 are inserted approximately midway along each corresponding recessed and protruding region 16, 26, 14, 24 of the respective disc and plate, thus twelve screws 30 in all. The actual number and position of the screws is not critical, although there should be several preferably equally spaced around the join between the disc and plate. The purpose of these screws 30 is primarily to resist any sideways dislodgement of either the disc 10 or the annular plate 20 as might occur on severe impact in use of the sprocket on a motorcycle. However, the presence of screws 30 is an additional resistance to any possibility of torque between the disc 10 and the annular plate 20, such torque already been precluded by the presence of the interfitting recessed and protruding regions 16, 26, 14, 24 of the disc 10 and the annular plate 20.

The foregoing is illustrative and not limitative of the scope of the invention and variations in detail, for example in the size and configuration of the disc and the annular plate and in the type of fastener, are possible in other embodiments.

1. A sprocket comprising an annular plate, which is of a first material and has a toothed external periphery, shrink fitted onto the perimeter of a disc of a second material so that there is no play between the annular plate and the disc, the perimeter of the disc having at least one radially recessed region and the annular plate having its inner edge provided with corresponding one or more protruding regions which fit thereto, and a plurality of fasteners inserted axially at spaced intervals between the annular plate and the disc.

2. A sprocket as set forth in claim 1 wherein the fasteners are grub screws.
